(19) United States
(12) Patent Application Publication
(10) Pub. No.: US 2004/0159044 A1
(43) Pub. Date: Aug. 19, 2004

(54) Houseplant care apparatus

(76) Inventor: Simon W. Burrow, Pasadena, CA (US)

Correspondence Address: L/O OF H. MICHAEL BRUCKER, 5855 DOYLE STREET, SUITE 110, EMERYVILLE, CA, 94608, US

(21) Appl. No.: 10/370,375

(22) Filed: Feb. 19, 2003

(51) Int. Cl. A01G 29/00

(52) U.S. Cl. 47/48.5

(57) ABSTRACT

A specially developed blend of premium plant nutrients that is mixed with pure spring water and conveniently packaged in a relatively small, easy-to-store and easy-to-use, disposable plastic container. Three premixed formula eliminates the need for a separate watering container and importantly eliminates the need to measure and mix ingredients. The plant nutrients of the present invention are especially formulated to provide to the house plants the precise amount of good required during each watering operation. The formulation, is chlorine fee, pH balanced and contains no heavy metals and no fluoride.

### BACKGROUND OF THE INVENTION

1. Field of the Invention

The present invention relates generally to plant care. More particularly the invention concerns a novel apparatus for the feeding and nourishment of houseplants

2. Discussion of the Prior Art

The care of houseplants presents a somewhat unusual situation. In the first place, most homes only have a few indoor houseplants that require care and, therefore, a large volume of liquid nutrient to fertilize and nourish the plants is not required. Secondly, the plant caregiver typically has only a very limited time to devote to the care of the plants, normally only a few minutes in the morning or in the evening. However, when the plant caregiver seeks to purchase a liquid plant food or fertilizer for use in the care of the houseplants, the only choice typically available is a rather large container of highly concentrated fertilizer. The highly concentrated fertilizer cannot be used directly from the container, but rather must be mixed with water. This requirement represents a substantial nuisance to the houseplant caregiver and requires the caregiver to indulge a messy and time-consuming task to mix the rather small volume of liquid nutrient necessary for the periodic care of the houseplants.

Liquid fertilizer is available in concentrated form from a number of suppliers, including the Schultz Company of Bridgeport, Mo., the Scotts Miracle Grow Products, Inc. of Marysville, Ohio, and Safer, Inc. of Lititz, Pa. The Schultz and Scotts Miracle Grow companies suggest that the highly concentrated liquid fertilizer be mixed with water using the cap of the fertilizer container as a measuring device. More particularly, the Schultz Company suggests that one-half capful of the concentrated fertilizer be mixed with two gallons of water. The Scotts Miracle Grow Company suggests that one capful of the concentrated liquid be mixed with two gallons of water. Safer, Inc., on the other hand, suggests that one tablespoon of the concentrated fertilizer be mixed with one gallon of water.

This required dilution of the concentrated liquid fertilizer by the plant caregiver is time-consuming and often difficult, particularly if the caregiver is elderly or infirm. If, during the dilution step, the liquid fertilizer is accidentally splashed into the eyes or spilled on the skin or on the clothing of the caregiver, potentially serious injury and damage can occur. This is evidenced by the fact that certain manufacturers of the concentrated liquid fertilizer include with their product a label that provides “Caution: May be harmful if swallowed, avoid contact with eyes, skin, open cuts or sores”.

As a general rule, the concentrated liquid fertilizer is diluted by the plant caregiver with tap water that may contain significant amounts of chlorine which may be harmful to certain types of houseplants. During the dilution step, a separate watering container must be obtained and filled with the required measured volume of water. Then using the container cap or a measuring spoon, the liquid fertilizer must be poured from its container into the small container cap or into the measuring spoon and then added to the container containing the tap water. After thoroughly mixing the liquid fertilizer with the tap water, the watering container can be used to feed the houseplants. If the watering container cannot be sealed, any remaining unused mixture must be discarded.

The thrust of the present invention is to overcome the problems identified in the preceding paragraphs by providing to the plant caregiver a specially developed blend of premium plant nutrients that is mixed with pure spring water and conveniently packaged in a relatively small, easy-to-store and easy-to-use, disposable plastic container. The premixed formula eliminates the need for a separate watering container and importantly eliminates the need to measure and mix ingredients.

The plant nutrients of the present invention are especially formulated to provide to the houseplants the precise amount of food required during each watering operation. The formulation, which is chlorine free, pH balanced and contains no heavy metals and no fluoride, is suitable for use with virtually all green and flowering houseplants even delicate African violets and orchids. The apparatus of the invention is easy to use since the premixed liquid nutrient can be conveniently poured directly from a container onto the soil in which the houseplants are planted until the soil becomes moist.

As will be better understood from the description which follows, the present invention avoids the need for time consuming and messy mixing of concentrated fertilizers with tap water, does not require a separate watering container and provides a convenient, sealable, and readily available source of premixed houseplant nutrient.

### SUMMARY OF THE INVENTION

It is an object of the present invention to provide in combination with an easy-to-use, disposable container, a formulation that can be poured directly from the container to provide houseplants of various varieties with the precise amount of food and nourishment required to ensure optimum care, feeding and nourishment of the houseplants.

Another object of the invention is to provide a combination of the aforementioned character that eliminates the need to measure and mix highly concentrated liquid fertilizer with water.

Another object of the invention is to provide a combination as described in the preceding paragraphs in which the formulation contained within the disposable plastic container component of the invention is chlorine free, pH balanced and contains no heavy metals and fluorides.

Another object of the invention is to provide a combination of the class described in which the formulation contained within the disposable container effectively hydrates the plants and is suitable for use with a wide variety of green and flowering houseplants.

Another object of the invention is to provide a combination as described in the preceding paragraphs in which the container component that contains the premixed formula is easy to use, is conveniently resealable and includes a suitable pouring spout that enables the user to easily pour the formulation onto the soil contained within small plants containing the houseplant to nourished.

These and other objects of the invention are achieved by the novel combination illustrated in the drawings and described in the paragraphs that follow.

### BRIEF DESCRIPTION OF THE DRAWINGS

FIG. 1 is a front view of one form of the combination of the invention with the container component of the combination partly broken away to show internal construction.

FIG. 2 is a front view, similar to FIG. 1, but showing a smaller, differently configured container for containing the formulation of the invention.

FIG. 3 is a side-elevational view partly broken away of yet another form of the invention in which the formulation component of the combination is contained within a differently configured container having a forwardly extending pouring spout.

FIG. 4 is a side-elevational view similar to FIG. 3, but illustrating still another form of the apparatus of the invention showing a container of a different configuration having an upwardly extending pouring spout.

### DISCUSSION OF THE INVENTION

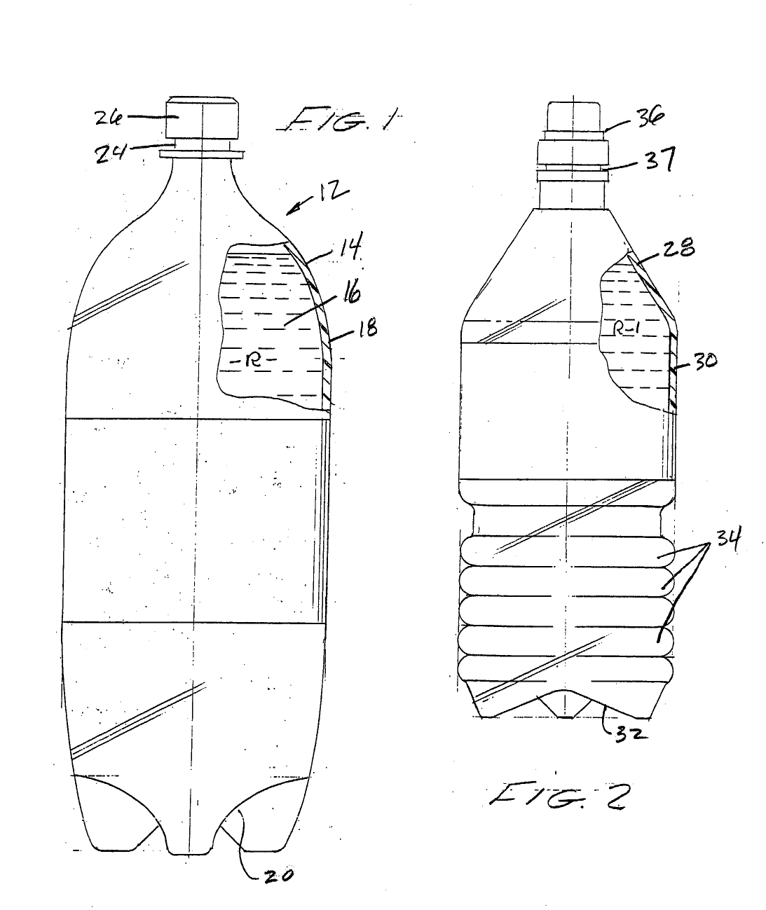

Referring to the drawings and particularly to FIG. 1 one form of the present invention is there shown and generally designated by the numeral 12. This form of the invention comprises, in combination with a sealable, disposable plastic container 14, a ready-to-use liquid plant nutrient 16 for nourishing and hydrating the houseplant. Container 14 includes side and bottom walls 18 and 20 respectively that define a reservoir “R” for containing the liquid plant nutrient 16.

To enable the liquid nutrient to be conveniently poured from the container 14 onto the soil within which the houseplant is planted, pouring means is provided. In the embodiment of the invention shown in FIG. 1, this pouring means comprises a sealable pouring spout 24 that can be conveniently sealed by a seal cap 26.

The specially developed blend of premium plant nutrients of the invention is mixed with pure, substantially chlorine free spring water and is provided to the user in an easy-to-use, disposable container such as plastic container 14. In one form of the invention, the nutrient formulation of the invention comprises the following

| | |
|---|---|
| Nitrogen | 0.002667% |
| Ammoniacal Nitrogen | 0.000333% |
| Nitrate Nitrogen | 0.000333% |
| Urea Nitrogen | 0.002000% |
| Soluble Potash | 0.002167% |
| Phosphate | 0.002500% |
| Chelated Iron | 0.000033% |
| Spring water (with trace minerals) | 99.992633% |

The foregoing formulation advantageously contains no chlorine, no salt, no chloramines, no heavy metals, and no fluoride. Additionally, the formulation is carefully pH balanced to provide optimum plant care.

As previously mentioned, the formulation is premixed and packaged within the container 14 so that no mixing of concentrated fertilizer with water is required. Rather the nutrient formula can be poured directly from the disposable plastic container in an amount necessary to moisten the soil around the houseplant. The container can then be resealed with the cap 26 and stored until the next plant feeding operation.

Referring to FIG. 2 of the drawings, an alternate form of the invention is there shown. This alternate form of the invention is somewhat similar to that shown in FIG. 1 and comprises a disposable plastic container 28 having side and bottom walls 30 and 32 that define a reservoir R-1 of a slightly different configuration than reservoir “R”. The lower portion of the container 29 is here provided with gripping means comprising a series of rib-like protuberances 34 that permit the container to be securely gripped by the user during the watering operation. As in the earlier described embodiment of the invention, the reservoir R-1 is sealed by a cap assembly 36 of conventional construction that closes the pouring means or spout 37.

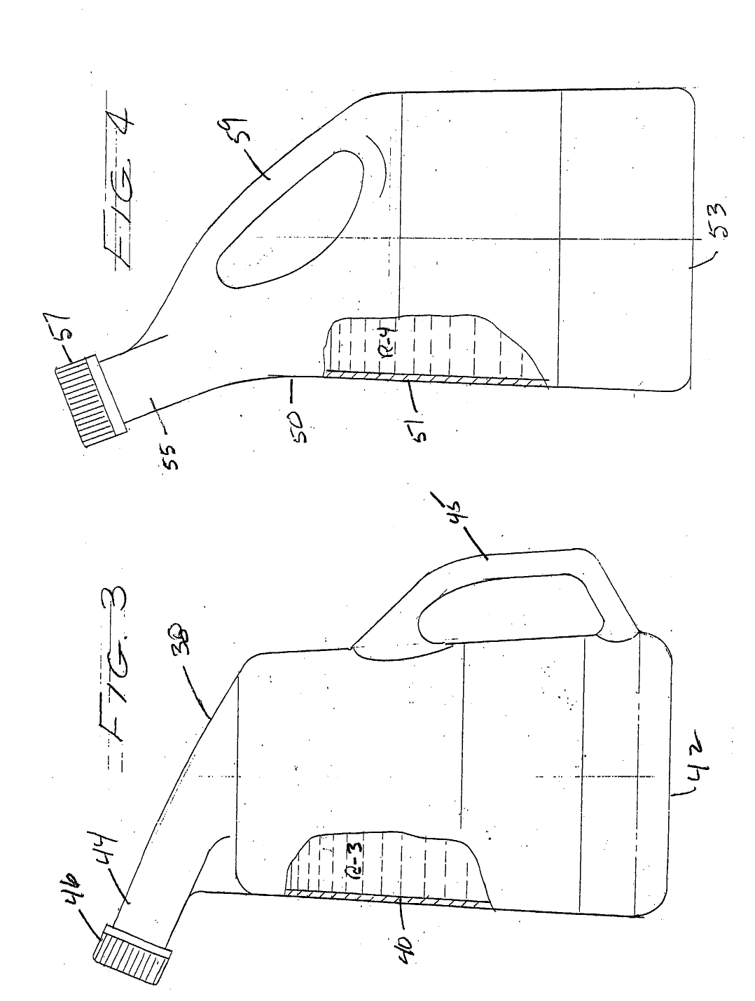

Turning next to FIG. 3, yet another form of the combination of the invention is illustrated. This form of the invention is similar in many respects to those previously described and here comprises a container 38 having side and bottom walls 40 and 42 that define still a differently configured reservoir R-3 that contains the nutrient formulation. This nutrient formulation is identical to that previously described and can be administered to the houseplant by means of a sealable pour spout 44 that extends upwardly from the container body and can be sealed by a sealing cap 46. Container 38 includes gripping means for gripping the container that here comprises a gripping handle 45.

Turning next to FIG. 4, still another form of the apparatus of the invention is there shown. This apparatus is similar in some respects to the apparatus shown in FIG. 3 and includes a container 50 having a side wall 51 and a bottom wall 53 that cooperate that define a reservoir R-4 for containing the nutrient formulation which is of the character previously described. The formulation can be easily and neatly dispensed from the container 53 through an upwardly extending pour spout 55 that is sealable by a seal cap 57. Once again, the container component includes gripping means in the form of a gripping handle 59.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. In combination with a disposable plastic container, a ready to use liquid plant nutrient for nourishing and hydrating a plant, said container having a sealable pour spout for pouring said liquid plant nutrient into an area located proximate the plant.

2. The combination as defined in claim 1 in which said liquid plant nutrient includes a mixture of spring water, nitrogen and phosphate.

3. The combination as defined in claim 2 in which said liquid plant nutrient further includes potash.

4. The combination as defined in claim 3 in which said liquid plant nutrient further includes chelated iron.

5. The combination as defined in claim 4 in which said liquid plant nutrient is pH balanced.

6. In combination with a disposable plastic container having a reservoir and a gripping means for gripping said plastic container, a ready to use liquid plant nutrient contained within said reservoir for nourishing and hydrating a plant, said container having a sealable pour spout in communication with said reservoir for pouring said liquid plant nutrient from said container into an area located proximate the plant, said liquid plant nutrient comprising a mixture of spring water, nitrogen, phosphate and potash.

7. The combination as defined in claim 6 in which said plastic container includes a body portion and in which said gripping means comprises a handle of fixed to said body portion.

8. The combination as defined in claim 7 in which said pour spout extends outwardly from said body portion.

9. The combination as defined in claim 7 in which said liquid plant nutrient further includes chelated iron.

10. The combination as defined in claim 9 in which said liquid plant nutrient is pH balanced.

11. In combination with a disposable plastic container having a reservoir and a gripping means for gripping said plastic container, a ready to use liquid plant nutrient contained within said reservoir for nourishing and hydrating a plant, said container having a sealable pour spout in communication was said reservoir for pouring said liquid plant nutrient from said container into an area located proximate the plant, said liquid plant nutrient comprising a mixture of 99.992633 percent spring water, 0.000333 percent ammoniacal nitrogen, 0.000333 percent nitrate nitrogen, 0.002000 percent urea nitrogen, 0.002500 percent phosphate, 0.002167 percent potash and 0.000033 percent chelated iron.

12. The combination as defined in claim 11 in which said liquid plant nutrient is pH balanced.

13. The combination as defined in claim 11 in which said plastic container includes a generally selling directly shaped body portion.

14. The combination as defined in claim 11 in which said plastic container includes body portion and in which said gripping means comprises a handle of fixed to said body portion.

15. The combination as defined in claim 14 in which said pour spout extends outwardly from said body portion.
